(19) United States
(12) Patent Application Publication
(10) Pub. No.: US 2025/0051563 A1
(43) Pub. Date: Feb. 13, 2025

(54) POLYCARBONATE COMPOSITIONS

(71) Applicant: SHPP GLOBAL TECHNOLOGIES B.V., Bergen op Zoom (NL)

(72) Inventors: Fabrizio Micciche, Breda (NL); Remco Wirtz, Bergen op Zoom (NL); Robert Dirk van de Grampel, Tholen (NL); Mark Adrianus Johannes van der Mee, Etten Leur (NL)

(21) Appl. No.: 18/716,617

(22) PCT Filed: Dec. 7, 2022
(86) PCT No.: PCT/IB2022/061904

§ 371 Date: Jun. 5, 2024

(30) Foreign Application Priority Data
Dec. 7, 2021 (EP) 21212818.5

(51) Int. Cl. C08L 69/00; C08K 5/524; C08K 5/5399

(52) U.S. Cl. CPC C08L 69/00; C08K 5/524; C08K 5/5399; C08L 2201/02; C08L 2205/025; C08L 2205/035

(57) ABSTRACT

A polycarbonate composition suitable for thin-wall applications comprises: a linear homopolycarbonate; a poly(carbonate-siloxane) present in an amount effective to provide 0.1 to 10 wt % siloxane, based on the total weight of the composition, a linear polycarbonate having pendant ester groups in an amount effective to provide 0.1 to 5.0 mole % repeating units derived from C a monomer having a pendant ester group based on the total moles of the composition; and a flame retardant wherein a molded sample N of the composition has a UL-94 flame test rating of VO at a thickness of 1.5 mm.

### CROSS REFERENCE TO RELATED APPLICATION

This application claims priority to European Application No. 21212818.5, filed Dec. 7, 2021, the content of which is incorporated by reference in its entirety.

### BACKGROUND

This disclosure relates to polycarbonate compositions, and in particular to flame-retardant polycarbonate compositions, methods of manufacture, and uses thereof in thin-wall articles.

Polycarbonates are useful in the manufacture of articles and components for a wide range of applications, from automotive parts to electronic appliances. Because of their broad use, particularly in electronics, it is desirable to provide polycarbonate compositions with excellent physical, optical, and thermal properties in an adequate processing window. Such properties can be particularly difficult to achieve in thin-wall applications. In addition, more stringent regulations are being put in place to reduce or eliminate the presence of halogen in the final products.

There accordingly remains a need in the art for flame-retardant polycarbonate compositions suitable for thin-wall applications. It would be a further advantage if the compositions were essentially halogen-free.

### SUMMARY

The above-described and other deficiencies of the art are met by a polycarbonate composition comprising: a linear homopolycarbonate; a poly(carbonate-siloxane) present in an amount effective to provide 0.1 to 10 wt % siloxane, based on the total weight of the composition, a linear polycarbonate having pendant ester groups in an amount effective to provide 0.1 to 5.0 mole % repeating units derived from a monomer having a pendant ester group based on the total moles of the composition; and a flame retardant.

In another aspect, a method of manufacture comprises combining the above-described components to form a polycarbonate composition.

In yet another aspect, an article comprises the above-described polycarbonate composition.

In still another aspect, a method of manufacture of an article comprises molding, extruding, or shaping the above-described polycarbonate composition into an article.

The above described and other features are exemplified by the following detailed description, examples, and claims,

### DETAILED DESCRIPTION

Polycarbonates are thermoplastic resins with many desirable properties, but are inherently flammable. The UL 94 flammability test includes both short flame out times and no dripping of flaming particles as requirements for a V0 or V1 flame test rating. Polycarbonates tend to drip when exposed to a flame, and this behavior worsens as the wall thickness decreases. Some conventional compositions incorporate fluorine-based anti-drip technology into compositions in order to pass UL94 flame test. Current design trends are focused on thinner designs for purposes of slimness, weight reduction, and size reduction of the overall final product, as well as to for the purpose of more complex designs. As mentioned above, more stringent regulations are being put in place to reduce or eliminate the presence of halogen in the final products.

The inventors hereof have discovered that polycarbonate compositions including a poly(carbonate-siloxane) and a linear polycarbonate comprising 0.1 to 5.0 mole % repeating units derived from a monomer having a pendant ester group based on the total moles of the composition in combination with a flame retardant can provide the desired flame retardance while minimizing or eliminating the halogen content. Surprisingly, unlike conventional compositions, in some aspects, conventional anti-drip agents such as TSAN can be omitted in the polycarbonate compositions, thus minimizing the fluorine content while providing the desired V0 flame test rating. Advantageously, the polycarbonate compositions can have a UL-94 flame test rating of V-0 at a thickness of 1.5 mm and be considered “essentially halogen-free” per IEC 61249-2-21 or UL 746H. As used herein, the phrase “essentially halogen-free” is as defined by IEC 61249-2-21 or UL 746H. According to International Electrochemical Commission, Restriction Use of Halogen (IEC 61249-2-21), a composition should include 900 parts per million (ppm) or less of each of chlorine and bromine and also include 1500 ppm or less of total bromine, chlorine, and fluorine content. According to UL 746H, a composition should include 900 ppm or less of each of chlorine, bromine, and fluorine and 1500 ppm or less of the total chlorine, bromine, and fluorine content. The bromine, chlorine, and fluorine content in ppm may be calculated from the composition or measured by elemental analysis techniques. Conventional flame retardants can include or exclude halogens, but commonly employed anti-drip agents include PTFE-encapsulated styrene-acrylonitrile copolymers (e.g., TSAN) and thus include fluorine. Flame retardants that are not brominated, chlorinated, or fluorinated have been used in conventional polycarbonate compositions, but an anti-drip agent is usually present in combination with the flame retardant, causing the halogen content of the composition to exceed the 1500 ppm total halogen limit per IEC 61249-2-21 and UL 746H. Similarly, when flame retardants that are not brominated or chlorinated, but are fluorinated are used in combination with a fluorinated anti-drip agent, then the halogen content of the composition due to the presence of fluorine exceeds the 1500 ppm total halogen limit per IEC 61249-2-21 or UL 746H. Therefore, it would be a particular advantage if conventional anti-drip agents could be minimized or eliminated, so that the anti-drip agent does not contribute halogen content to the total halogen content of the compositions. In the polycarbonate compositions described herein, the combination of the poly(carbonate-siloxane) and the polycarbonate having pendant ester groups can act as an anti-drip agent, thus avoiding the use of a conventional anti-drip agent. Accordingly, a variety of flame retardants that include or exclude halogens can be used in polycarbonate compositions so that the compositions can be considered “essentially halogen-free” per TEC 61249-2-21 or UL 746H.

The polycarbonate compositions include a certain polycarbonate comprising a linear homopolycarbonate, a poly(carbonate-siloxane); a linear polycarbonate comprising 0.1 to 5.0 mole % repeating units derived from a monomer having a pendant ester group based on the total moles of the composition; and a flame retardant. Optional components of the polycarbonate compositions include and a reinforcing composition and an additive composition. The individual components of the polycarbonate compositions are described in detail below.

“Polycarbonate” as used herein means a polymer having repeating structural carbonate units of formula (1)

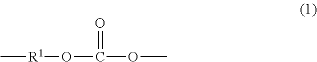

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ may be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ may be derived from a bisphenol of formula (3)

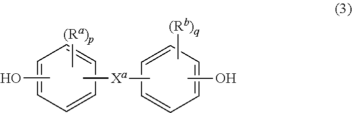

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3). X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group may be cyclic or acyclic, aromatic or non-aromatic, and may further comprise heteroatoms such as halogens, oxygen, nitrogen, sulfur, silicon, or phosphorous. The 1-60 organic group may be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

Other useful dihydroxy compounds of the formula HO—R¹—OH include aromatic dihydroxy compounds of formula (6)

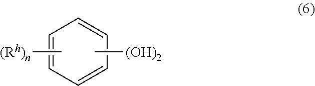

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

The polycarbonates may have an intrinsic viscosity, as determined in chloroform at 25° C., of 0.3 to 1.5 deciliters per gram (dl/gm), preferably 0.45 to 1.0 dl/gm. The polycarbonates may have a weight average molecular weight (Mw) of 10,000 to 200,000 Daltons, preferably 20.000 to 100,000 Daltons, as measured by gel permeation chromatography (GPC), using a crosslinked styrene-divinylbenzene column using polystyrene standards and calculated for polycarbonate. GPC samples are prepared at a concentration of 1 mg per ml, and are eluted at a flow rate of 1.5 ml per minute.

The polycarbonate compositions may include a homopolycarbonate (wherein each R¹ in the polymer is the same). In an aspect, the homopolycarbonate in the polycarbonate composition is derived from a bisphenol of formula (2), preferably bisphenol A, in which each of A¹ and A² is p-phenylene and Y¹ is isopropylidene in formula (2).

In some aspects, the polycarbonate is a bisphenol A homopolycarbonate. The bisphenol A homopolycarbonate may have: a melt flow rate of 3-50, per 10 min at 300° C. and a 1.2 kg load and a Mw of 17,000-40,000, g/mole, preferably 20,000-30.000 g/mole, more preferably 21,000 to 23,0000, each as measured as described above. In some aspects, the polycarbonate comprises a linear bisphenol A homopolycarbonate. In some aspects, the polycarbonate comprises a linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; or a linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate; or a combination thereof.

The linear homopolycarbonate may be present, for example, from 10-95 wt %, 20-90 wt %, 30-90 wt %, 40-90 wt %, 50-90 wt %, 60-90 wt %, 60-70 wt %, 20-60 wt %, 20-50 wt %, or 20-40 wt %, based on the total weight of the polycarbonate composition.

“Polycarbonates” include homopolycarbonates (wherein each R in the polymer is the same) and copolymers comprising different R¹ moieties in the carbonate (“copolycarbonates”), and copolymers comprising carbonate units and other types of polymer units, such as ester units or siloxane units.

The polycarbonate compositions include one or more poly(carbonate-siloxane)s, also referred to in the art as polycarbonate-polysiloxane copolymers. The polysiloxane blocks comprise repeating diorganosiloxane units as in formula (10)

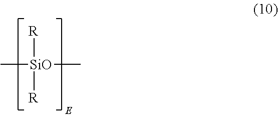

wherein each R is independently a C₁₋₁₃ monovalent organic group. For example, R may be a C₁₋₁₃ alkyl, C₁₋₁₃ alkoxy. C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups may be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups may be used in the same copolymer.

The value of E in formula (10) may vary widely depending on the type and relative amount of each component in the polycarbonate composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it may be desirable to use a relatively larger amount of the poly(carbonate-siloxane) copolymer. Conversely, where E is of a higher value, e.g., greater than 40, a relatively lower amount of the poly(carbonate-siloxane) copolymer may be used. A combination of a first and a second (or more) poly(carbonate-siloxane) copolymers may be used, wherein the average value of E of the first copolymer is less than the average value of E of the second copolymer.

In an aspect, the polysiloxane blocks are of formula (11)

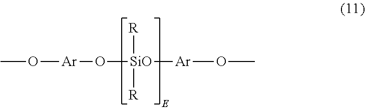

wherein E and R is each as defined if formula (10); each R may be the same or different, and is as defined above; and Ar may be the same or different, and is a substituted or unsubstituted C₆₋₃₀ arylene, wherein the bonds are directly connected to an aromatic moiety. Ar groups in formula (11) may be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (13)

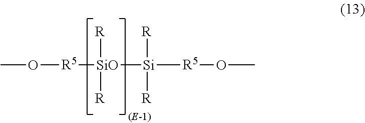

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (14):

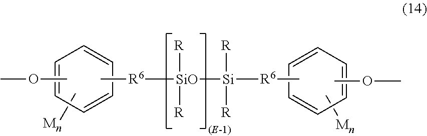

wherein R and E are as defined above. R⁶ in formula (14) is a divalent C₂₋₈ aliphatic group. Each M in formula (14) may be the same or different, and may be a halogen, cyano, nitro, C₁₋₈ alkylthio. C₁₋₈ alkyl, C₁₋₈ alkoxy. C₂₋₈ alkenyl, C₂₋₈ alkenyloxy, C₃₋₈ cycloalkyl, C₃₋₈ cycloalkoxy. C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

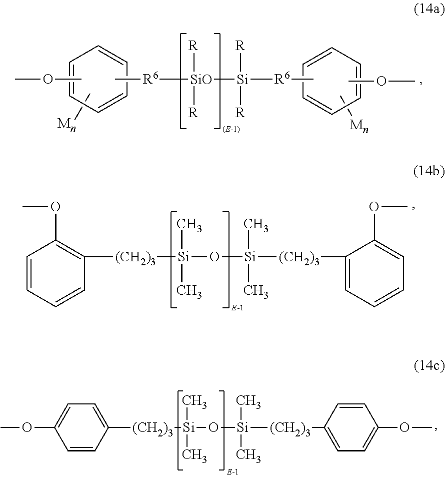

or a combination thereof, wherein E has an average value of 2 to 200, 2 to 125, 5 to 125, 5 to 100, 5 to 50, 20 to 80, or 5 to 20.

Blocks of formula (14) may be derived from the corresponding dihydroxy polysiloxane, which in turn may be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers may then be manufactured, for example, by the synthetic procedure of European Patent Application Publication No. 0 524 731 A 1 of Hoover, page 5, Preparation 2.

Transparent poly(carbonate-siloxane) copolymers comprise carbonate units (1) derived from bisphenol A, and repeating siloxane units (14a), (14b), (14c), or a combination thereof (preferably of formula 14a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A 1 or the process described in U.S. Pat. No. 6,723,864 can be used to synthesize the poly(carbonate-siloxane) copolymers.

The poly(carbonate-siloxane) copolymers can comprise 50 to 99 wt % of carbonate units and 1 to 50 wt % siloxane units. Within this range, the poly(carbonate-siloxane) copolymer can comprise 70 to 98 wt %, more preferably 75 to 97 wt % of carbonate units and 2 to 30 wt %, more preferably 3 to 25 wt % siloxane units.

The poly(carbonate-siloxane) copolymers may comprise 50 to 99 wt % of carbonate units and 1 to 50 wt % siloxane units. Within this range, the poly(carbonate-siloxane) copolymer may comprise 70 to 98 wt %, more preferably 75 to 97 wt % of carbonate units and 2 to 45 wt %, more preferably 5 to 10 or 30 to 45 wt % siloxane units.

In an aspect, a blend is used, in particular a blend of a bisphenol A homopolycarbonate and a poly(carbonate-siloxane) block copolymer of bisphenol A blocks and eugenol capped polydimethylsiloxane blocks, of the formula

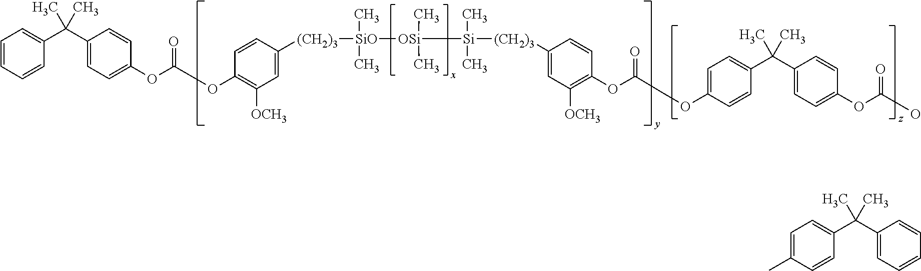

wherein x is 1 to 200, preferably 5 to 85, preferably 10 to 70, preferably 15 to 65, and more preferably 40 to 60; x is 1 to 500, or 10 to 200, and z is 1 to 1000, or 10 to 800. In an aspect, x is 1 to 200, y is 1 to 90 and z is 1 to 600, and in another aspect, x is 30 to 50, y is 10 to 30 and z is 45 to 600. The polysiloxane blocks may be randomly distributed or controlled distributed among the polycarbonate blocks.

Poly(carbonate-siloxane)s may have a weight average molecular weight of 2,000 to 100,000 g/mol, preferably 5,000 to 50,000 g/mol as measured by gel permeation chromatography using a crosslinked styrene-divinyl benzene column, at a sample concentration of 1 milligram per milliliter, using polystyrene standards and calculated for polycarbonate.

The poly(carbonate-siloxane)s may have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane)s of different flow properties may be used to achieve the overall desired flow property.

One or more poly(carbonate-siloxane) copolymers can be included in the polycarbonate compositions. The polycarbonate compositions can include a poly(carbonate-siloxane) copolymer having a siloxane repeating units of greater than 30 to 70 wt %, based on the total weight of the poly(carbonate-siloxane) copolymer. Within this range, the poly(carbonate-siloxane) can have a siloxane repeating units of 35 to 70 wt %, or 35 to 65 wt %. As used herein, “siloxane repeating units” of a poly(carbonate-siloxane) refers to the content of siloxane units based on the total weight of the poly(carbonate-siloxane). The polycarbonate compositions can include a poly(carbonate-siloxane) copolymer having a siloxane repeating units of greater than 10 to 30 wt %, based on the total weight of the poly(carbonate-siloxane). Within this range, the poly(carbonate-siloxane) copolymer can have a siloxane repeating units of 15 to 25 wt %. The polycarbonate compositions can include a poly(carbonate-siloxane) copolymer having a siloxane repeating units of 10 wt % or less, based on the total weight of the poly(carbonate-siloxane). Within this range, the poly(carbonate-siloxane) copolymer can have a siloxane repeating units of 4 to 8 wt %. The polycarbonate compositions can include two or more of the foregoing.

The polycarbonate compositions may include from 0.1-10 wt %, 0.1 to 8 wt %, 1 to 8 wt %, 0.1 to 6 wt %, 1 to 6 wt %, 2 to 6 wt %, or 3 to 6 wt % of siloxane repeating units, each based on the total composition.

In addition to linear homopolycarbonate and a poly(carbonate-siloxane), the polycarbonate compositions include a linear polycarbonate having pendant ester groups. The linear polycarbonate includes a repeating unit derived from a bisphenol and a repeating unit derived from a monomer having the pendant ester group. The monomer having the pendant ester group has the structure

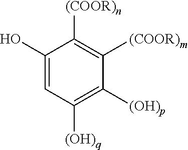

wherein R is C₂-C₁₅ alkyl; each of m, n, p, and q are 0 or 1; m+n=1; and p+q=1. In some aspects, the monomer having pendant ester groups is a branched ester. In some aspects, R is ethyl, isopropyl, sec-butyl, tert-butyl, or isopentyl, preferably ethyl or isopropyl, more preferably isopropyl. In some aspects, at least one type of monomer having a pendant ester group may be present. In some aspects, a single-type monomer having a pendant ester group may be present. For example, the pendant ester group of the monomer may be ethyl, wherein monomers having a pendant ester group other than ethyl are absent. In some aspects, two or more types of monomer having a pendant ester group may be present. For example, the polycarbonate having pendant ester groups may include pendant ethyl ester groups, pendant isopropyl ester groups, or a combination thereof. The polycarbonate having pendant ester groups may be present in an amount effective to provide 0.1-5.0 mol %, 0.1 to 4.5 mol %, 0.1-4.0 mol %, 0.1-3.5 mol %, 0.1-3.0 mol %, 0.1-2.5 mol %, or 0.1-2.0 mol % ester repeating units, each based on the total moles of the composition.

The linear polycarbonate having pendant ester groups comprising a repeating unit derived from a bisphenol and a repeating unit derived from a monomer having a pendant ester group may have a weight average molecular weight of 26,000 to 40,000 g/mol or 26,000 to 35,000 g/mol, each measured by GPC using polystyrene standards and calculated for polycarbonate. As used herein, “using polystyrene standards and calculated for polycarbonate” refers to measurement of the retention time by GPC, fitting the retention time value to a curve for polystyrene and calculating the molecular weight for polycarbonate. In some aspects, the polycarbonate having pendant ester groups comprising a repeating unit derived from a bisphenol and a repeating unit derived from a monomer having a pendant ester group may include bisphenol A repeating units. In some aspects, the polycarbonate having pendant ester groups may include bisphenol A repeating units and repeating units derived from a monomer having ethyl ester pendant groups, isopropyl ester pendant groups, or a combination thereof.

Polycarbonates may be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) may be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups may be used. Branched polycarbonate blocks may be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of 0.05 to 4.0 wt %, preferably 0.25 to 2.0 wt %. Combinations comprising linear polycarbonates and branched polycarbonates may be used.

An end-capping agent (also referred to as a chain stopper agent or chain terminating agent) may be included during polymerization to provide end groups. The end-capping agent (and thus end groups) are selected based on the desired properties of the polycarbonates. Exemplary end-capping agents are exemplified by monocyclic phenols such as phenol and C₁₋₂₂ alkyl-substituted phenols such as p-cumyl-phenol, resorcinol monobenzoate, and p- and tertiary-butyl phenol, monoethers of diphenols, such as p-methoxyphenol, and alkyl-substituted phenols with branched chain alkyl substituents having 8 to 9 carbon atoms, 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, mono-carboxylic acid chlorides such as benzoyl chloride, C₁₋₂₂ alkyl-substituted benzoyl chloride, toluoyl chloride, bromobenzoyl chloride, cinnamoyl chloride, and 4-nadimidobenzoyl chloride, polycyclic, mono-carboxylic acid chlorides such as trimellitic anhydride chloride, and naphthoyl chloride, functionalized chlorides of aliphatic monocarboxylic acids, such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups may be used.

The polycarbonate compositions include a flame retardant. Inorganic flame retardants may be used, for example salts of C₂₋₁₆ alkyl sulfonates such as potassium perfluorobutane sulfonate (Rimar salt), potassium perfluoroctane sulfonate, and tetraethylammonium perfluorohexane sulfonate, salts of aromatic sulfonates such as sodium benzene sulfonate, sodium toluene sulfonate (NATS), and the like, salts of aromatic sulfone sulfonates such as potassium diphenylsulfone sulfonate (KSS), and the like; salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃, or a fluoro-anion complex such as Li₃AF₆, BaSiF₆, KBF₄, K₃AlF₆, KAlF₄, K₂SiF₆, or Na₃AlF₆ or the like. Rimar salt and KSS and NATS, alone or in combination with other flame retardants, are particularly useful. Rimar salt and KSS and NATS, alone or in combination with other flame retardants, are particularly useful. The perfluoroalkyl sulfonate salt may be present in an amount of 0.30 to 1.00 wt %, preferably, 0.40 to 0.80 wt %, more preferably, 0.45 to 0.70 wt %, based on the total weight of the composition. The aromatic sulfonate salt may be present in the final polycarbonate composition in an amount of 0.01 to 0.1 wt %, preferably, 0.02 to 0.06 wt %, and more preferably, 0.03 to 0.05 wt %. Exemplary amounts of aromatic sulfone sulfonate salt may be 0.01 to 0.6 wt %, preferably, 0.1 to 0.4 wt %, and more preferably, 0.25 to 0.35 wt %, based on the total weight of the polycarbonate composition.

The polycarbonate compositions can include an organophosphorous flame retardant. In the aromatic organophosphorous compounds that have at least one organic aromatic group, the aromatic group may be a substituted or unsubstituted C₃₋₃₀ group containing one or more of a monocyclic or polycyclic aromatic moiety (which may optionally contain with up to three heteroatoms (N, O, P, S. or Si)) and optionally further containing one or more nonaromatic moieties, for example alkyl, alkenyl, alkynyl, or cycloalkyl. The aromatic moiety of the aromatic group may be directly bonded to the phosphorous-containing group, or bonded via another moiety, for example an alkylene group. The aromatic moiety of the aromatic group may be directly bonded to the phosphorous-containing group, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination comprising at least one of the foregoing.

The phosphorous-containing group may be a phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the foregoing phosphorous-containing groups may be the same or different, provided that at least one R is an aromatic group. A combination of different phosphorous-containing groups may be used. The aromatic group may be directly or indirectly bonded to the phosphorous, or to an oxygen of the phosphorous-containing group (i.e., an ester).

In an aspect the aromatic organophosphorous compound is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups may be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic organophosphorous compounds are also useful, for example, compounds of the formulas

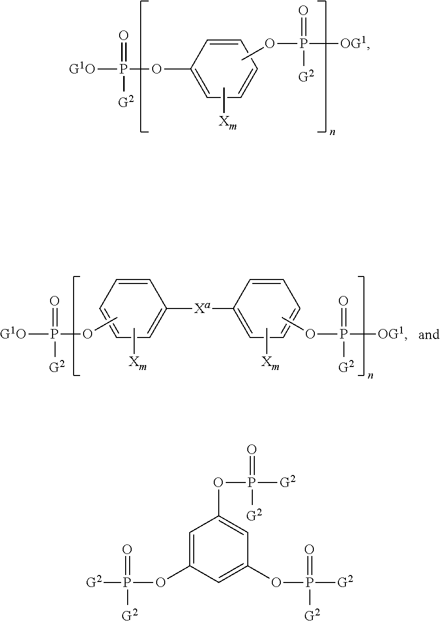

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific aromatic organophosphorous compounds are inclusive of acid esters of formula (9)

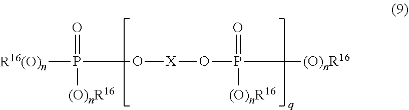

wherein each R¹⁶ is independently C₁₋₈ alkyl, C₅₋₆cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which may be OH-substituted and may contain up to 8 ether bonds, provided that at least one R or X is an aromatic group; each n is independently 0 or 1; and q is from 0.5 to 30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

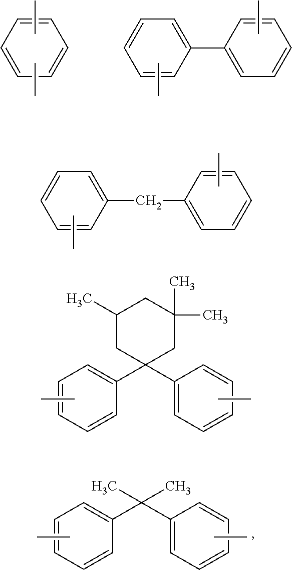

or a combination comprising one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Aromatic organophosphorous compounds of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorous flame retardant containing a phosphorous-nitrogen bond may be a phosphazene, phosphonitrilic chloride, phosphorous ester amide, phosphoric acid amide, phosphonic acid amide, phosphinic acid amide, or tris(aziridinyl) phosphine oxide. These flame-retardant additives are commercially available. In an aspect, the organophosphorous flame retardant containing a phosphorous-nitrogen bond is a phosphazene or cyclic phosphazene of the formulas

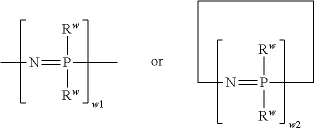

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one hydrogen atom of these groups may be substituted with a group having an N, S, O, or F atom, or an amino group. For example, each R^{w} may be a substituted or unsubstituted phenoxy, an amino, or a polyoxyalkylene group. Any given R^{w} may further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

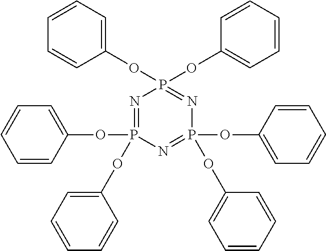 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

When the flame retardant includes an organophosphorous flame retardant, the organophosphorous flame retardant may be present in an amount effective to provide 0.05-1.0 wt %, 0.05-0.8 wt %, 0.05-0.6 wt %, or 0.05-0.5 wt % phosphorous, each based on the total weight of the composition.

The polycarbonate composition can include various additives ordinarily incorporated into polymer compositions of this type, with the proviso that the additive(s) are selected so as to not significantly adversely affect the desired properties of the polycarbonate composition, in particular flame resistance, impact resistance and the melt volume rate. Such additives can be mixed at a suitable time during the mixing of the components for forming the composition. Additives include antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, and anti-drip agents. A combination of additives can be used, for example a combination of a heat stabilizer, mold release agent, and ultraviolet light stabilizer. In general, the additives are used in the amounts generally known to be effective. For example, the total amount of the additives (other than any impact modifier, filler, or reinforcing agents) can be 0.01 to 5 wt %, based on the total weight of the polycarbonate composition.

In some aspects, the polycarbonate compositions include a bisphenol A homopolycarbonate, optionally having a weight average molecular weight from 18,000-27,000 grams/mole, preferably from 20,000-25,000 grams/mole and a bisphenol A homopolycarbonate having a weight average molecular weight from 27,000-35,000 grams/mole, preferably 29,000-31,000 grams/mole, each determined using polystyrene standards and calculated for polycarbonate; a poly(carbonate-siloxane) comprising greater than 10 wt % to less than 30% siloxane repeating units present in an amount effective to provide 0.1 to 10 wt % siloxane, based on the weight of the total composition; and 5-30 wt % of a linear polycarbonate comprising bisphenol carbonate units and greater than 0.1-5.0 mole % repeating units derived from a monomer having a pendant ester group based on the total moles of the composition; and an organophosphorous flame retardant present in amount effective to provide 0.05-1.0 wt % phosphorous.

In some aspects, the polycarbonate compositions include a bisphenol A homopolycarbonate, optionally, having a weight average molecular weight from 18,000-27,000 grams/mole, preferably from 20,000-25,000 grams/mole and a bisphenol A homopolycarbonate having a weight average molecular weight from 27,000-35,000 grams/mole, preferably 29,000-31,000 grams/mole, each determined using polystyrene standards and calculated for polycarbonate: a poly(carbonate-siloxane) comprising greater than 10 wt % to less than 30% siloxane repeating units; and 5-30 wt % of a linear polycarbonate comprising bisphenol carbonate units and greater than 0.1 to 5.0 mole % repeating units derived from a monomer having a pendant ester group based on the total moles of the composition; and an aromatic phosphazene flame retardant present in amount effective to provide 0.05 to 1.0 wt % phosphorous. In some aspects, the polycarbonate compositions include a linear bisphenol A homopolycarbonate; a poly(carbonate-siloxane) comprising 30 wt % to 70 wt % siloxane repeating units and optionally comprising a poly(carbonate-siloxane) comprising 10 wt % or less siloxane repeating units; a linear polycarbonate having pendant ester groups in an amount effective to provide 0.1 to 5.0 mole % repeating units derived from a monomer having a pendant ester group based on the total moles of the composition; and an aromatic phosphazene flame retardant present in amount effective to provide 0.05 to 1.0 wt % phosphorous.

The polycarbonate compositions can be substantially free of a branched polycarbonate. As used herein, “substantially free of a branched polycarbonate” means that the polycarbonate compositions include 10 wt % or less, 5 wt % or less, 1 wt % or less, or 0.1 wt % or less of a branched polycarbonate. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid.

The polycarbonate compositions can be substantially free of chlorine and bromine. “Substantially free of chlorine and bromine” refers to materials produced without the intentional addition of chlorine or bromine or chlorine or bromine containing materials. It is understood however that in facilities that process multiple products a certain amount of cross contamination can occur resulting in bromine or chlorine levels typically on the parts per million by weight scale. With this understanding it can be readily appreciated that “substantially free of bromine and chlorine” can be defined as having a bromine or chlorine content of less than or equal to 100 parts per million by weight (ppm), less than or equal to 75 ppm, or less than or equal to 50 ppm. In some aspects, “substantially free of bromine and chlorine” means a total bromine and chlorine content of less than or equal to 100 parts per million by weight, or less than or equal to 75 ppm, or less than or equal to 50 ppm. When this definition is applied to the flame retardant it is based on the total weight of the flame retardant. When this definition is applied to the reinforced polycarbonate composition it is based on the total parts by weight of the reinforced polycarbonate composition.

In another aspect, the polycarbonate composition can be substantially free of chlorine, bromine, and fluorine. “Substantially free of chlorine, bromine, and fluorine” is defined as having a bromine, chlorine, or fluorine content of less than or equal to 100 ppm, less than or equal to 75 ppm, or less than or equal to 50 ppm, based on the total parts by weight of the composition. Preferably, the polycarbonate composition has a combined bromine, chlorine, and fluorine content of less than or equal to 100 ppm, less than or equal to 75 ppm, or less than or equal to 50 ppm, based on the total parts by weight of the composition.

The polycarbonate compositions can be manufactured by various methods. For example, powdered polycarbonates, flame retardant, and/or optional components are first blended, optionally with fillers in a HENSCHEL-Mixer high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat or downstream through a sidestuffer. Additives can also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared can be one-fourth inch long or less as desired. Such pellets can be used for subsequent molding, shaping, or forming.

A molded sample of the polycarbonate composition can have a flame test rating of V0, as measured according to UL-94 at a thickness of 1.5 millimeter and less.

Shaped, formed, or molded articles comprising the polycarbonate compositions are also provided. The polycarbonate compositions can be molded into useful shaped articles by a variety of methods, such as injection molding, extrusion, rotational molding, blow molding and thermoforming. Some examples of articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. In an aspect, the article is an extruded article, a molded article, pultruded article, a thermoformed article, a foamed article, a layer of a multi-layer article, a substrate for a coated article, or a substrate for a metallized article. In addition, the polycarbonate compositions can be used for such applications as a molded housing and other devices such as electrical circuit housing.

This disclosure is further illustrated by the following examples, which are non-limiting.

### EXAMPLES

The following components are used in the examples. Unless specifically indicated otherwise, the amount of each component is in wt %, based on the total weight of the composition.

The materials shown in Table 1 were used.

TABLE 1

| PC-1 | Linear amorphous bisphenol A polycarbonate (BPA) homopolymer produced by | SABIC |
|---|---|---|
| | interfacial polymerization (Mw 29,000-31,000 g/mol, using polystyrene | |
| | standards) | |
| PC-2 | Linear amorphous BPA homopolymer produced by interfacial polymerization | SABIC |
| | (Mw 20,000-22,000, using polystyrene standards) | |
| PC-3 | Poly(bisphenol A - dimethylsiloxane) copolymer, produced via interfacial | SABIC |
| | polymerization, 20 wt % siloxane, average siloxane block length = 45 units | |
| | (D45), Mw = 29,000 to 31,000 g/mol per d by GPC using polystyrene standards, | |
| | para-cumylphenol (PCP) end-capped | |
| PC-4 | 4/96 mol % amorphous IDHB-BPA copolymer produced by interfacial | SABIC |
| | polymerization, Mw 29,000-31,000 g/mol, using polystyrene standards | |
| PC-5 | 4/96 mol % amorphous EDHB-BPA copolymer produced by interfacial | SABIC |
| | polymerization, Mw 29,000-31,000 g/mol, using polystyrene standards | |
| PC-6 | Poly(bisphenol A carbonate-dimethylsiloxane) copolymer having a siloxane | SABIC |
| | repeating units of 40 wt %, average PDMS block length of 45 units, having a Mw | |
| | of 37,000 to 38,000 grams per mole as determined by GPC using polystyrene | |
| | standards and calculated for polycarbonate, produced by interfacial | |
| | polymerization and endcapped with p-cumylphenol | |
| PC-7 | Branched, cyanophenol end-capped bisphenol A homopolycarbonate produced | SABIC |
| | via interfacial polymerization, containing 3 mol % 1,1,1-tris(4- | |
| | hydroxyphenyl)ethane (THPE) branching agent (Mw = 29,000-31,000 g/mol, | |
| | using polystyrene standards) | |
| PC-8 | PDMS (polydimethylsiloxane)-Bisphenol A polycarbonate copolymer, 6 wt % | SABIC |
| | siloxane, average PDMS block length 45 units (D45), Mw 22,000-24,000 g/mol | |
| | as determined by GPC using polycarbonate standards, eugenol end-capped | |
| SolDP | Oligomeric phosphate ester, available as FYROLFLEX SOL-DP (10.7 wt % | ICL |
| | phosphorous) | INDUSTRIAL |
| PPZ | Phenoxy phosphazene, 13.94 wt % phosphorous | Fushimi |
| KSS | Potassium diphenylsulfone sulfonate | Sloss Industries |
| RIMAR | Potassium perfluorobutane sulfonate | 3M |
| PETS | Pentaerythrityl tetrastearate, >90% esterified | Faci |
| AO | Tris(di-t-butyl phenyl)phosphite, CAS Reg. No. 31570-04-4 | Ciba |
| TSAN | Encapsulated Polytetrafluoroethylene, CAS Reg. No. 9002-84-0, with 47-53 wt % | SABIC |
| | poly(tetrafluoroethylene) | |
| UVA | 2-(2Hydroxy-5-tert-octylphenyl) benzotriazole, commercially available as UVA | CIBA |
| | 5411 | |

General Procedure for PC-4 and PC-5. In a pre-formulation tank, 7 L water, 23 L methylene chloride, 4200 g BPA, 40 mL TEA, 10 g sodium gluconate, and propan-2-yl 3,5-dihydroxybenzoate (IDHB) or Ethyl 3,5-dihydroxybenzoate (EDHB) are added and well mixed. The resulting formulation is then transferred to the reactor, where phosgene is then added at 90 g/min and the mixture is recirculated. To maintain a pH of 9-10, a 30% caustic solution is then added at a program-determined rate. During the course of the phosgenation, a solution of PCP in methylene chloride (184 g PCP/800 g methylene) is added at 200 g/min. Phosgenation continues until a total of 2400 g of phosgene is delivered. Following completion of reaction, the reaction's MW is checked along with the presence of any excess phosgene. The reaction mixture is neutralized with dilute acid (to remove TEA and neutralize base) and the organic layer is separated from the aqueous layer after centrifugation. The organic layer is then washed with deionized water and separated again by centrifugation. The organic layer is then subjected to steam precipitation, and the resin is isolated as a wet powder and then dried in nitrogen dryer.

The testing samples were prepared as described below and the following test methods were used.

Typical compounding procedures are described as follows: The various formulations were prepared by direct dry-blending of the raw materials and pre-blended and then extruded using a twin-screw extruder. The composition was melt-kneaded, extruded, cooled through a water bath and pelletized. A typical extrusion profile is listed in Table 2.

TABLE 2

| Parameters | Unit | Typical values |
|---|---|---|
| Feed | ° C. | 40 |
| Zone 1 Temp | ° C. | 200 |
| Zone 2 Temp | ° C. | 240 |
| Zone 3 Temp | ° C. | 260 |
| Zone 4-9 Temp | ° C. | 280 |
| Screw Speed | rpm | 300 |
| Throughput | kg/br | ~24 |
| Torque | % | Max. |

An Engel 45 molding machine was used to mold the test parts for standard physical property testing. The parameters are provided in Table 3.

TABLE 3

| Parameters | Unit | Conditions |
|---|---|---|
| Drying Temperature | ° C. | 120 |
| Drying Time | hrs | 2 |
| Hopper temperature | ° C. | 40 |
| Nozzle Temperature | ° C. | 275 |
| Rear - Zone 1 Temperature | ° C. | 260 |
| Middle - Zone 2 Temperature | ° C. | 270 |
| Front - Zone 3 Temperature | ° C. | 280 |

Sample preparation and testing methods are described in Table 4.

TABLE 4

| Property | Standard | Conditions | Specimen Type |
|---|---|---|---|
| MVR | ISO-1133 | 300° C., 2.16 kg, 300 sec | pellets |
| Notched | ASTM | 23° C., −30° C. | Bar-63.5 mm × 12.7 |
| Izod (NII) | D256 | | mm × 3.2 mm |
| Flammability | UL 94 | Vertical Burning | |

Flammability tests were performed on samples at a thickness of 1.5 mm, 1.0 mm, and 0.8 mm in accordance with the Underwriter's Laboratory (UL) UL 94 standard. In some cases, a second set of 5 bars was tested to give an indication of the robustness of the rating. In this report the following definitions are used as shown in Table 5. Total flame-out-times for all 5 bars (FOT=t1+t2) were determined. V-ratings were obtained for every set of 5 bars.

TABLE 5

| UL94 Rating | t₁ and/or t₂ | 5-bar FOT | burning drips |
|---|---|---|---|
| V0 | <10 | <50 | no |
| V1 | <30 | <250 | no |
| V2 | <30 | <250 | yes |
| N.R. (no rating) | >30 | >250 | |

### Examples 1-12

Table 6 shows the compositions and properties for the following comparative examples and examples. Comparative examples are indicated with an asterisk.

TABLE 6

| | Unit | 1* | 2* | 3* | 4* | 5* | 6 | 7 | 8 | 9 | 10 | 11* | 12* |
|---|---|---|---|---|---|---|---|---|---|---|---|---|---|
| PC-1 | wt % | 39.4 | 38.21 | 38.01 | 36.61 | 37 | 32.91 | 32.91 | 15.31 | 26.61 | 15.31 | 16.31 | 15.31 |
| PC-2 | wt % | 37.46 | 39 | 39 | 39.2 | 38.81 | 32.91 | 32.91 | 39 | 39.2 | 39 | 39.2 | 39 |
| PC-3 | wt % | 22.2 | 22.2 | 22.2 | 22.2 | 22.2 | 22.2 | 22.2 | 22.2 | 22.2 | 22.2 | 22.2 | 22.2 |
| PC-4 | wt % | | | | | | 10 | 10 | 20 | | | | |
| PC-5 | wt % | | | | | | | | | 10 | 20 | | |
| PC-7 | wt % | | | | | | | | | | | 20 | 20 |
| AO | wt % | 0.09 | 0.09 | 0.09 | 0.09 | 0.09 | 0.09 | 0.09 | 0.09 | 0.09 | 0.09 | 0.09 | 0.09 |
| PETS | wt % | 0.1 | 0.1 | 0.1 | 0.1 | 0.1 | 0.1 | 0.1 | 0.1 | 0.1 | 0.1 | 0.1 | 0.1 |
| UV | wt % | 0.3 | 0.3 | 0.3 | 0.3 | 0.3 | 0.3 | 0.3 | 0.3 | 0.3 | 0.3 | 0.3 | 0.3 |
| TSAN | wt % | 0.45 | | 0.45 | | | | | | | | | |
| Rimar | wt % | | 0.1 | | | | | | | | | | |
| KSS | wt % | | | 0.3 | | | | | | | | | |
| SolDP | wt % | | | | 1.5 | | 1.5 | | | | | | |
| PPZ | | | | | | 1.5 | | 1.5 | 3 | 1.5 | 3 | 1.5 | 3 |
| Total | wt % | 100 | 100 | 100 | 100 | 100 | 100 | 100 | 100 | 100 | 100 | 100 | 100 |
| Ester | wt % | 0 | 0 | 0 | 0 | 0 | 0.4 | 0.4 | 0.8 | 0.4 | 0.8 | 0 | 0 |
| Siloxane | wt % | 4.44 | 4.44 | 4.44 | 4.44 | 4.44 | 4.44 | 4.44 | 4.44 | 4.44 | 4.44 | 4.44 | 4.44 |
| % F | wt % | 0.16 | 0.05 | 0 | 0 | 0 | 0 | 0 | 0 | 0 | 0 | 0 | 0 |
| % P | wt % | 0 | 0 | 0 | 0.18 | 0.195 | 0.18 | 0.195 | 0.39 | 0.195 | 0.39 | 0.195 | 0.39 |

Properties

| | | | | | | | | | | | | | |
|---|---|---|---|---|---|---|---|---|---|---|---|---|---|
| ΣFOT | sec | 45.3 | 106 | 98 | 40.4 | 45.2 | 41.20 | 17.50 | 28.7 | 45 | 24.3 | TBD | TBD |
| Flaming | — | 0 | 0 | 5 | 2 | 0 | 0 | 0 | 0 | 0 | 0 | | |
| drips | | | | | | | | | | | | | |
| UL94 | — | V0 | NR | NR | V2 | V2 | V0 | V0 | V0 | V0 | V0 | | |
| @1.5 | | | | | | | | | | | | | |
| mm | | | | | | | | | | | | | |
| MVR | cm³/10 | 7.9 | 10.1 | 8.5 | 11.4 | 10.4 | 8.2 | 7.8 | 9.3 | 11.0 | 11.6 | TBD | TBD |
| | min | | | | | | | | | | | | |

Table 6 shows that compositions containing a combination of a homopolycarbonate, a poly(carbonate-siloxane), a linear polycarbonate having a pendant ester group, and an organophosphorous flame retardant can provide a UL-94 flame test rating of V0 at 1.5 mm thickness, while also providing improved flame-out times.

Comparative Examples 1-5 do not include a linear polycarbonate having a pendant ester group. A molded sample of Comparative Example 1, which does not include a flame retardant, but does include an anti-drip agent has a UL-94 flame test rating of V0 at a 1.5 mm thickness, but also a flame out time close to 50 seconds (i.e., 45.3 seconds). Comparative Examples 2-5, that include a flame retardant, but no anti-drip agent, failed to provide a UL-94 flame test rating of V0 at a 1.5 mm thickness and failed to substantially improve the flame-out times. Examples 6-8 incorporate a linear polycarbonate having a pendant ester group (isopropyl) combined with an organophosphorous flame retardant. Example 6 includes a combination of an oligomeric flame retardant (SOL-DP), whereas Examples 7-8 include a phosphazene (PPZ). Molded samples of Examples 7-8 provided the desired UL-94 flame test rating of V0 at a 1.5 mm thickness as well as an improved flame-out time (i.e., 17.5 and 28.7 seconds, respectively). Examples 9-10 include a linear polycarbonate having a pendant ester group (ethyl) combined with a phosphazene flame retardant. Although both molded samples of Examples 9-10 provided a UL 94 flame test rating of V0 at a 1.5 mm thickness, Example 10 showed a substantially improved flame-out time as compared with Example 9. Comparative Examples 11 and 12 do not include a linear polycarbonate having a pendant ester group, but instead incorporate a branched polycarbonate (PC-7).

### Examples 13-15

Table 7 shows the compositions and properties for the following examples.

TABLE 7

| | | 13 | 14 | 15 |
|---|---|---|---|---|
| PC-1 | wt % | 16 | | |
| PC-2 | wt % | 40.21 | 30.71 | 36.21 |
| PC-4 | wt % | 30 | 30 | |
| PC-5 | wt % | | | 50 |
| PC-6 | wt % | 11.1 | 6.6 | 11.1 |
| PC-8 | wt % | | 30 | |
| Phosphite | wt % | 0.09 | 0.09 | 0.09 |
| PETS | wt % | 0.3 | 0.1 | 0.1 |
| UV-Stab | wt % | 0.3 | 0.3 | 0.3 |
| PPZ | wt % | 2.0 | 2.0 | 2.0 |
| Total | wt % | 100 | 100 | 100 |
| Ester content | wt % | 1.2 | 1.2 | 1.2 |
| Siloxane | wt % | 4.44 | 4.44 | 4.44 |
| repeating units | | | | |
| % F | wt % | 0 | 0 | 0 |
| % P | wt % | 0.6 | 0.26 | 0.26 |

Properties

| | | | | |
|---|---|---|---|---|
| ΣFOT | sec | 28 | 34 | 23 |
| Flaming drips | — | 0 | 0 | 0 |
| UL94 @1.5 mm | — | V0 | V0 | V0 |
| MVR | cm³/10 min | | | |

Examples 13-15 include compositions having a poly(carbonate-siloxane) having a siloxane repeating units other than 20 wt % and phosphazene as a flame retardant that provide a V0 flame test rating at a thickness of 1.5 mm. Examples 13-14 are directed to compositions including IDHB, whereas Example 15 is directed to a composition including EDHB. Examples 13 and 15 include a poly(carbonate-siloxane) having 40 wt % siloxane repeating units. Example 14 includes a composition having a combination of a poly(carbonate-siloxane)s. Specifically, Example 14 includes a poly(carbonate-siloxane) having 40 wt % siloxane repeating units and a poly(carbonate-siloxane) having 6 wt % siloxane repeating units.

TABLE 8
Prophetic Comparative Examples

| | | 16* | 17* | 18* | 19* |
|---|---|---|---|---|---|
| PC-1 | wt % | 8 | 8 | 8 | 8 |
| PC-2 | wt% | 72.51 | 62.51 | 52.51 | 52.51 |
| PC-6 | wt % | 15 | 15 | 15 | 15 |
| PC-7 | wt % | | | | 20 |
| Phosphite | wt % | 0.09 | 0.09 | 0.09 | 0.09 |
| PETS | wt % | 0.1 | 0.1 | 0.1 | 0.1 |
| UV-Stab | wt % | 0.3 | 0.3 | 0.3 | 0.3 |
| TSAN | wt % | 0.5 | | | |
| PPZ | wt % | 3.5 | 3.5 | 3.5 | 3.5 |
| PC-4 | wt % | | | | 0 |
| Total | wt % | 100 | 100 | 100 | 100 |
| Ester content | wt % | 0 | 0 | 0 | 0 |
| % F | wt % | 0.11 | 0 | 0 | 0 |
| % P | wt % | 0.49 | 0.49 | 0.49 | 0.49 |

This disclosure further encompasses the following aspects.

Aspect 1. A polycarbonate composition comprising: a linear homopolycarbonate; a poly(carbonate-siloxane) present in an amount effective to provide 0.1 to 10 wt % siloxane, based on the total weight of the composition, a linear polycarbonate having pendant ester groups in an amount effective to provide 0.1 to 5.0 mole % repeating units derived from a monomer having a pendant ester group based on the total moles of the composition; and a flame retardant, wherein a molded sample of the composition has a UL-94 flame test rating of V0 at a thickness of 1.5 mm.

Aspect 1b. The polycarbonate composition of Aspect 1, wherein the composition comprises less than 1500 ppm fluorine.

Aspect 1c. The polycarbonate composition of Aspect 1, wherein the composition comprises less than 0.2 wt % of an anti-drip agent.

Aspect 1d. The polycarbonate composition of Aspect 1, wherein the composition comprises less than less 0.1 wt % of an anti-drip agent.

Aspect 1e. The polycarbonate composition of Aspect 1, wherein the composition comprises less than less 0.05 wt % of an anti-drip agent.

Aspect 1f. The polycarbonate composition of Aspect 1, wherein the composition comprises less than less 0.05 wt % of an anti-drip agent

Aspect 1g. The polycarbonate composition of Aspect 1, wherein the composition comprises 1500 ppm or less of total bromine, chlorine, and fluorine content.

Aspect 2. The polycarbonate composition of Aspect 1, wherein the monomer having the ester pendant group has the structure

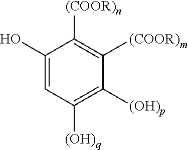

(H)q wherein R is C₂-C₁₅ alkyl; each of m, n, p, and q are 0 or 1; m+n=1; and p+q=1.

Aspect 3. The polycarbonate composition of Aspect 2, wherein R is ethyl or isopropyl.

Aspect 4. The polycarbonate composition of any one of the preceding aspects comprising a poly(carbonate-siloxane) having greater than 10 wt % to less than 30 wt % siloxane repeating units, a poly(carbonate-siloxane) having 30 wt % to 70 wt % siloxane repeating units, a poly(carbonate-siloxane) having less than 10 wt % siloxane repeating units, or a combination thereof.

Aspect 4a. The polycarbonate composition of any one of the preceding aspects comprising a poly(carbonate-siloxane) having 10 wt % or less siloxane repeating units, a poly(carbonate-siloxane) having 30 wt % to 70 wt % siloxane repeating units, or a combination thereof.

Aspect 4b. The polycarbonate composition of any one of the preceding aspects, wherein one or more poly(carbonate-siloxane)s are present in an amount effective to provide 0.1 to 6 wt % siloxane, based on the total weight of the composition.

Aspect 5. The polycarbonate composition of any one of the preceding aspects, wherein the polycarbonate composition is substantially free of a branched polycarbonate.

Aspect 6. The polycarbonate composition of any one of the preceding aspects, wherein the flame retardant comprises a C₂₋₁₆ alkyl sulfonate, an aromatic sulfonate, or a combination thereof.

Aspect 7. The polycarbonate composition of any one of the preceding aspects, wherein the flame retardant comprises an organophosphosphorous flame retardant comprising a monomeric or oligomeric phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the may be the same or different, provided that at least one R is an aromatic group; a monomeric or oligomeric compound having at least one phosphorous-nitrogen bond; or a combination thereof.

Aspect 8. The polycarbonate composition of any one of the preceding aspects, wherein the flame retardant comprises an organophosphosphorous flame retardant comprising

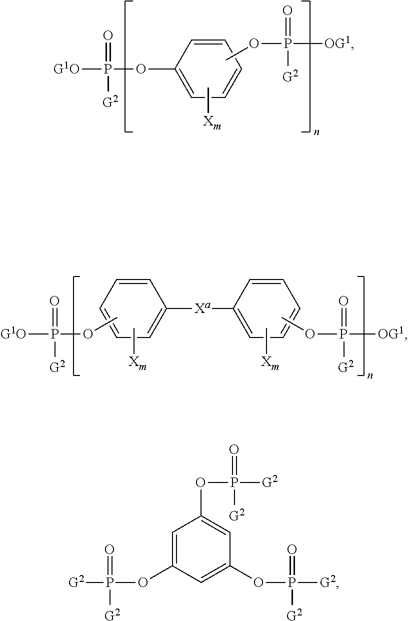

or a combination thereof, wherein each occurrence of G¹ is independently a C₁₋₃₀ hydrocarbyl: each occurrence of G² is independently a C₁₋₃₀ hydrocarbyl or hydrocarbyloxy; each X is independently a bromine or chlorine; m is 0 to 4, and n is 1 to 30;

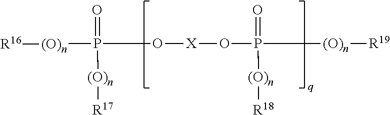

wherein R¹⁶, R¹⁷, R¹⁸, and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, preferably by C₁₋₄ alkyl and X is a mono- or poly-nuclear aromatic C₆₋₃₀ moiety or a linear or branched C₂₋₃₀ aliphatic radical, each optionally OH-substituted and optionally comprising up to 8 ether bonds, provided that at least one of R¹⁶, R¹⁷, R¹⁸, R¹⁹, and X is an aromatic group; or a combination thereof.

Aspect 9. The polycarbonate composition of any one of the preceding aspects, wherein the wherein the flame retardant comprises an organophosphosphorous flame retardant comprising phosphonitrilic chloride, phosphorous ester amide, phosphoric acid amide, phosphonic acid amide, phosphinic acid amide, or tris(aziridinyl) phosphine oxide; or a phosphazene or cyclic phosphazene of the formulas

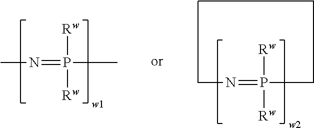

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group, optionally wherein at least one hydrogen atom is replaced with an N, S, O, or F atom, or an amino group.

Aspect 10. The polycarbonate composition of any one of the preceding aspects comprising: a linear bisphenol A homopolycarbonate; a poly(carbonate-siloxane) comprising greater than 10 wt % to less than 30% siloxane repeating units present in an amount effective to provide 0.1 to 10 wt % siloxane, based on the weight of the total composition; and a linear polycarbonate having pendant ester groups in an amount effective to provide 0.1 to 5.0 mole % repeating units derived from a monomer having a pendant ester group based on the total moles of the composition; and an organophosphorous flame retardant present in amount effective to provide 0.05 to 1.0 wt % phosphorous.

Aspect 11. The polycarbonate composition of any one of the preceding aspects comprising a linear bisphenol A homopolycarbonate; a poly(carbonate-siloxane) comprising greater than 10 wt % to less than 30% siloxane repeating units; and a linear polycarbonate having pendant ester groups in an amount effective to provide 0.1 to 5.0 mole % repeating units derived from a monomer having a pendant ester group based on the total moles of the composition; and an aromatic phosphazene flame retardant present in amount effective to provide 0.05 to 1.0 wt % phosphorous.

Aspect 12. The polycarbonate composition of any one of the preceding comprising: a linear bisphenol A homopolycarbonate; a poly(carbonate-siloxane) comprising 30 wt % to 70 wt % siloxane repeating units and optionally comprising a poly(carbonate-siloxane) comprising 10 wt % or less siloxane repeating units; a linear polycarbonate having pendant ester groups in an amount effective to provide 0.1 to 5.0 mole % repeating units derived from a monomer having a pendant ester group based on the total moles of the composition; and an aromatic phosphazene flame retardant present in amount effective to provide 0.05 to 1.0 wt % phosphorous.

Aspect 13. The polycarbonate composition of any one of the preceding aspects, wherein the polycarbonate composition comprises 0.1 wt % or less of an anti-drip agent comprising fluorine, preferably wherein the polycarbonate composition excludes an anti-drip agent comprising fluorine.

Aspect 14. An article comprising the polycarbonate composition of any one of the preceding aspects, preferably wherein the article is a housing for monitors, a housing for a handheld electronic device, preferably a housing for a cell phone or a personal health care device, a housing for a consumer electronic device, preferably a battery housing, a covers, or a display panel, a housing for an electrical component, preferably an electric vehicle charger, a smart meter cover, a smart meter box, or a lighting component; an electrical connector; a component of a lighting fixture; an ornament; a home appliance; a roof; a greenhouse enclosure, a sun room enclosure, and a swimming pool enclosure.

Aspect 15. A method for forming the article according to aspect 14, comprising molding, casting, or extruding the composition to provide the article.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polycarbonate composition comprising a linear homopolycarbonate;
a poly(carbonate-siloxane) present in an amount effective to provide 0.1 to 10 wt % siloxane repeating units, based on the total weight of the composition,
a linear polycarbonate having pendant ester groups in an amount effective to provide 0.1 to 5.0 mole % repeating units derived from a monomer having a pendant ester group based on the total moles of the composition; and
a flame retardant,
wherein a molded sample of the composition has a UL-94 flame test rating of V0 at a thickness of 1.5 mm.

2. The polycarbonate composition of claim 1, wherein the monomer having the ester pendant group has the structure 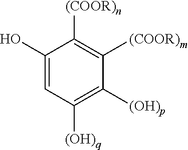
wherein R is C₂-C₁₅ alkyl; each of m, n, p, and q are 0 or 1; m+n=1; and p+q=1.

3. The polycarbonate composition of claim 2, wherein R is ethyl or isopropyl.

4. The polycarbonate composition of claim 1 comprising a poly(carbonate-siloxane) having greater than 10 wt % to less than 30 wt % siloxane repeating units, a poly(carbonate-siloxane) having 30 wt % to 70 wt % siloxane repeating units, a poly(carbonate-siloxane) having less than 10 wt % siloxane repeating units, or a combination thereof.

5. The polycarbonate composition of claim 1, wherein the polycarbonate composition is substantially free of a branched polycarbonate.

6. The polycarbonate composition of claim 1, wherein the flame retardant comprises a C₂₋₁₆ alkyl sulfonate, an aromatic sulfonate, or a combination thereof.

7. The polycarbonate composition of claim 1, wherein the flame retardant comprises an organophosphorus flame retardant comprising
a monomeric or oligomeric phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the may be the same or different, provided that at least one R is an aromatic group;
a monomeric or oligomeric compound having at least one phosphorous-nitrogen bond;
or a combination thereof.

8. The polycarbonate composition of claim 1, wherein the flame retardant comprises an organophosphorus flame retardant comprising 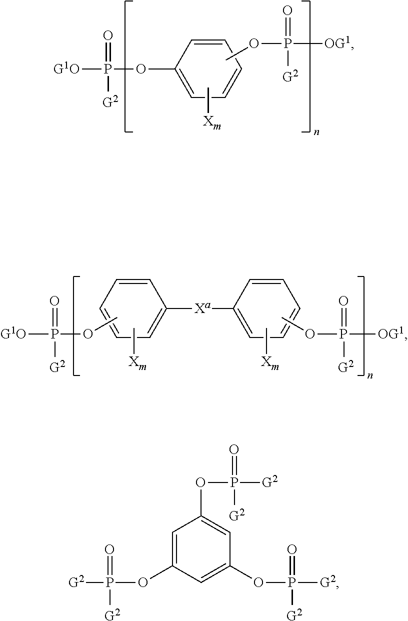
or a combination thereof,
wherein each occurrence of G¹ is independently a C₁₋₃₀ hydrocarbyl; each occurrence of G² is independently a C₁₋₃₀ hydrocarbyl or hydrocarbyloxy; each X is independently a bromine or chlorine; m is 0 to 4, and n is 1 to 30; 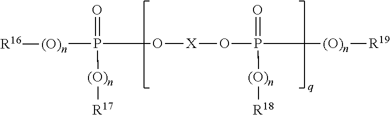
wherein R¹⁶, R¹⁷, R¹⁸, and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl and X is a mono- or poly-nuclear aromatic C₆₋₃₀ moiety or a linear or branched C₂₋₃₀ aliphatic radical, each optionally OH-substituted and optionally comprising up to 8 ether bonds, provided that at least one of R¹⁶, R¹⁷, R¹⁸, R¹⁹, and X is an aromatic group;
or a combination thereof.

9. The polycarbonate composition of claim 1, wherein the wherein the flame retardant comprises an organophosphorus flame retardant comprising
phosphonitrilic chloride, phosphorous ester amide, phosphoric acid amide, phosphonic acid amide, phosphinic acid amide, or tris(aziridinyl) phosphine oxide; or
a phosphazene or cyclic phosphazene of the formulas 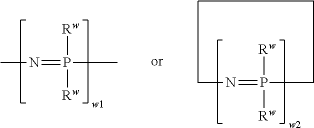
wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group, optionally wherein at least one hydrogen atom is replaced with an N, S, O, or F atom, or an amino group.

10. The polycarbonate composition of claim 1 comprising
a linear bisphenol A homopolycarbonate;
a poly(carbonate-siloxane) comprising greater than 10 wt % to less than 30% siloxane repeating units present in an amount effective to provide 0.1 to 10 wt % siloxane, based on the weight of the total composition; and
a linear polycarbonate having pendant ester groups in an amount effective to provide 0.1 to 5.0 mole % repeating units derived from a monomer having a pendant ester group based on the total moles of the composition; and
an organophosphorous flame retardant present in amount effective to provide 0.05 to 1.0 wt % phosphorous.

11. The polycarbonate composition of claim 1 comprising
a linear bisphenol A homopolycarbonate;
a poly(carbonate-siloxane) comprising greater than 10 wt % to less than 30% siloxane repeating units; and
a linear polycarbonate having pendant ester groups in an amount effective to provide 0.1 to 5.0 mole % repeating units derived from a monomer having a pendant ester group based on the total moles of the composition; and
an aromatic phosphazene flame retardant present in amount effective to provide 0.05 to 1.0 wt % phosphorus.

12. The polycarbonate composition of claim 1 comprising
a linear bisphenol A homopolycarbonate;
a poly(carbonate-siloxane) comprising 30 wt % to 70 wt % siloxane repeating units and optionally comprising a poly(carbonate-siloxane) comprising 10 wt % or less siloxane repeating units;
a linear polycarbonate having pendant ester groups in an amount effective to provide 0.1 to 5.0 mole % repeating units derived from a monomer having a pendant ester group based on the total moles of the composition; and
an aromatic phosphazene flame retardant present in amount effective to provide 0.05 to 1.0 wt % phosphorus

13. The polycarbonate composition of claim 1, wherein the polycarbonate composition comprises 0.1 wt % or less of an anti-drip agent comprising fluorine.

14. An article comprising the polycarbonate composition of claim 1.

15. A method for forming the article according to claim 14, comprising molding, casting, or extruding the composition to provide the article.

16. The polycarbonate composition of claim 1, wherein the polycarbonate composition comprises 0.1 wt % or less of anti-drip agent comprising fluorine.

17. The article of claim 15, wherein the article is a housing for a monitor, a housing for a handheld electronic device a cell phone or a personal health care device, or a housing for a consumer electronic device.

18. The article of claim 15, wherein the article is a battery housing, a cover, or a display panel, or a housing for an electrical component.

19. The article of claim 15, wherein the article is an electric vehicle charger, a smart meter cover, a smart meter box, or a lighting component; an electrical connector, a component of a lighting fixture; an ornament; a home appliance; a roof; a greenhouse enclosure, a sun room enclosure, or a swimming pool enclosure.
